(19) United States
(12) Patent Application Publication
(10) Pub. No.: US 2026/0322676 A1
(43) Pub. Date: Oct. 15, 2026

(54) Computer-Implemented Method for Configuring a Hierarchical Network Architecture

(71) Applicant: Robert Bosch GmbH, Stuttgart (DE)

(72) Inventors: Marie-Theres Suer, Braunschweig (DE); Abdulkadir Karaagac, Renningen (DE); Jan Hoffmann, Pforzheim (DE)

(21) Appl. No.: 19/640,774

(22) Filed: Apr. 7, 2026

(30) Foreign Application Priority Data
Apr. 10, 2025 (DE) 10 2025 114 163.0

(51) Int. Cl. H04L 41/044; H04L 41/0896; H04L 67/125

(52) U.S. Cl. CPC H04L 41/044; H04L 41/0896; H04L 67/125

(57) ABSTRACT

A computer-implemented method for configuring a hierarchical network architecture is disclosed. The network architecture includes at least a first layer and a second layer, wherein the first layer includes a first controller, and wherein the second layer includes a plurality of subnetworks and, for each subnetwork, a second controller. The method includes (i) determining, by way of the first controller, an end-to-end configuration for the first layer, (ii) allocating, by way of the first controller, a resource budget to each subnetwork corresponding to the end-to-end configuration, (iii) communicating, by way of the first controller, the respective allocated resource budget to each second controller, and (iv) creating, by way of each second controller, a resource plan for the subnetworks and configuring the network architecture if the resource budget transmitted to the respective second controller is sufficient, or transmitting a response from the second controller to the first controller if the transmitted resource budget is not sufficient for the second controller.

This application claims priority under 35 U.S.C. § 119 to application no. DE 10 2025 114 163.0, filed on Apr. 10, 2025 in Germany, the disclosure of which is incorporated herein by reference in its entirety.

The disclosure relates to a computer-implemented method for configuring a hierarchical network architecture.

### BACKGROUND

Deterministic networking (DetNet) is a technology designed specifically for industrial communication requirements. In industry 4.0 connected factories, reliable and time-critical data transfers play a critical role as production processes become increasingly automated and interconnected. DetNet ensures that data packets are transported with predictable latency, high reliability, and no losses, thereby ensuring that machines and control systems interact optimally with each other.

The technical implementation of DetNet is based on a combination of various components and methods. Key elements are deterministic queueing mechanisms, time synchronization, and precise resource allocation within the network. Techniques such as time-sensitive networking (TSN) and reserved bandwidth ensure that critical data streams are not compromised by unpredictable delays or network congestion. In addition, redundant paths and forwarding mechanisms allow for increased resiliency, so that even in the event of a connection failure, communication remains uninterrupted.

The value of DetNet is evident primarily in industrial applications where real-time communication is essential. In smart factories, robots, machines, and control systems need to operate in a synchronized manner to execute production processes efficiently and flawlessly. Especially in areas such as process automation, control of autonomous vehicles on production floors, or real-time monitoring of critical systems, DetNet enables smooth and precise control. Deterministic data transfer helps avoid production downtime and increases the efficiency of connected systems, ultimately leading to improved product quality and lower operating costs.

Utilizing DetNet and TSN simultaneously within a network architecture presents various challenges that primarily result from the different concepts and areas of application of the two technologies. While TSN is primarily based on ensuring time-critical communication at the data link layer and enabling deterministic transmission within local networks, DetNet addresses an end-to-end guarantee for time-bound data flows across larger, often heterogeneous networks. The integration of both approaches requires precise alignment of the mechanisms for time synchronization, resource reservation, and error handling, as otherwise inconsistencies in QoS assurance may arise.

A key problem lies in the interoperability of the time control mechanisms. TSN relies on precise time synchronization within a local area, but when data packets are routed through a DetNet backbone with potentially variable latencies, delays or jitter can arise that make it harder to meet strict timing requirements. In addition, TSN uses specific mechanisms for prioritizing and buffering data streams that do not always align seamlessly with the bandwidth reservation and packet forwarding methods used by DetNet. Improper configuration or insufficient alignment of these technologies can result in the loss of deterministic characteristics and thus compromise the reliability of the entire system.

Another issue arises from the varying demands placed on network resources. While TSN typically acts within a single segment of an industrial network and reserves bandwidth and buffers there, DetNet must extend these principles across larger network infrastructures, resulting in increased administrative overhead and more complex routing decisions. This requires end-to-end coordination of all network nodes involved to ensure that critical data streams are passed through with guaranteed latency and no packet loss. Adopting erroneous or inefficient reservation strategies can result in bottlenecks or even compromise less prioritized data streams.

In addition, error handling is challenging because TSN and DetNet utilize different redundancy and recovery mechanisms. TSN relies on mechanisms such as Frame Replication and Elimination for Reliability (FRER), while DetNet relies on a combination of redundancy pathways and explicit error correction. If these methods are not optimally aligned with each other, unexpected packet loss or inefficient utilization of network resources may occur. The successful coexistence of TSN and DetNet, therefore, requires a thoughtful architecture that integrates both technologies to preserve their respective benefits without mutually interfering with their mechanisms.

In environments where TSN and DetNet coexist, it is not advantageous to configure TSN and DetNet separately via their respective controllers, without each being aware of the other technology. This may lead to undesirable effects and poor performance. The disclosure is thus based on the task of suggesting a method for configuring a common architecture of DetNet and TSN, with which the above-mentioned disadvantages and problems can be solved.

Thus, in this disclosure, a common controller is proposed that organizes the entire end-to-end QoS.

The task is solved according to the disclosure by the subject-matter set forth below.

### SUMMARY

According to a first aspect of the disclosure, this task is solved with a computer-implemented method for configuring a hierarchical network architecture, wherein the network architecture (20) comprises at least a first layer and a second layer, wherein the first layer comprises a first controller, and wherein the second layer comprises a plurality of subnetworks and, for each subnetwork, a second controller, wherein the method comprises the following steps:
determining, by way of the first controller, an end-to-end configuration (S10) for the first layer;
allocating, by way of the first controller, a resource budget (S12) to each subnetwork corresponding to the end-to-end configuration;
communicating, by way of the first controller, the respective allocated resource budget (S14) to each second controller; and
creating, by way of each second controller, a resource plan for the subnetworks and configuring the network architecture (20, S18) if the resource budget transmitted to the second controller is sufficient, or transmitting a response (S20) from the second controller to the first controller if the transmitted resource budget is not sufficient for that second controller.

The first controller according to the present disclosure organizes the entire end-to-end configuration. Depending on the network architecture, this configuration may already be known to the first controller; otherwise, the first controller must first determine the configuration.

Explicit end-to-end paths are required in DetNet to provide a stable forwarding service, and to ensure that the DetNet service is not compromised as the network topology changes. To implement explicit paths in a DetNet architecture, these paths must meet the application's Service Level Agreement (SLA) requirements, which include limited bandwidth, maximum end-to-end delay, maximum end-to-end delay variation, maximum loss rate, etc. In a distributed network system, IGP can be used with CSPF (Constrained Shortest Path First) to calculate a series of viable paths for a DetNet service. In a centralized network system, a controller may calculate paths that meet the requirements of the DetNet based on the network information collected in the DetNet domain.

If the configuration is known, each second controller in the second layer is assigned a resource budget for its respective subnetwork.

There are several types of resources on the network that can be assigned to the second controllers, e.g., packet processing resources, buffer resources, and output port bandwidth. The network resource requested by a particular DetNet service is determined by the SLA requirements and the network capacity.

The second layer may otherwise comprise a plurality of subnetworks arranged in parallel to one another in the hierarchical network architecture, but not directly communicatively connected to one another.

The resource budgets assigned to the second controllers are transmitted from the first controller to the respective second controllers. Each of the second controllers, with the resource budget allocated to it, in turn determines a resource plan for its individual subnetwork. If the network topology or application traffic or requirements change, the resource plan should be recalculated. If the resource budgets assigned to the second controllers are sufficient and a resource plan has been created for each subnetwork, the hierarchical network architecture is configured. If appropriate, the second controllers may be configured to transmit a corresponding response to the first controller after successful resource plan creation, so that the first controller can treat the network architecture as configured.

If the resource budget of a second controller is not sufficient for its respective subnetwork, the respective second controller transmits a response to the first controller.

In this way, the first controller may coordinate a plurality of second controllers responsible for their respective subnets. This common use of TSN and DetNet layers can be beneficial in high-demand scenarios for network determinism. The foregoing method thus introduces the configuration of an architecture for a DetNet controller that handles a common configuration of TSN and DetNet layers. In this way, end-to-end determinism can also be ensured in more complex networks with multiple subnetworks. The task underlying the disclosure is hereby solved.

In one embodiment, the first layer is a DetNet layer and the first controller is a DetNet controller.

In one embodiment, the second layer is a TSN layer and the second controllers are TSN controllers.

In one embodiment, the method is repeated if the resource budget is not sufficient for one of the second controllers.

The first controller may assign resource budgets again if a response is received from at least one second controller, taking into account the fact that the previous allocation was insufficient in at least one case.

In one embodiment, the response comprises a request for a larger resource budget, in particular a minimum size for the resource budget.

With the request for a larger resource budget, the first controller can perform the reallocation of the resource budgets more efficiently. In particular, if the response includes a minimum size for the resource budgets, the first controller may directly address the corresponding requirements of the second controller whose subnetwork requires a higher resource budget.

In one embodiment, the response comprises a specification of an actually required time budget, wherein the response is also transmitted to the first controller even if the resource budget allocated to the respective second controller is sufficient.

If the resource budget actually needed is transmitted from the second controllers to the first controller, the first controller may optimize the resource allocation. If the response is also transmitted to the first controller even if the resource budget allocated to the respective second controller exceeds the requirements of the respective subnetwork, resources may be withdrawn from the second controllers for which they are not needed.

In one embodiment, the data traffic within the network is restricted for one or more second controllers if the resource budget is not sufficient for one of the second controllers, wherein a higher resource budget is allocated to the unrestricted second controllers.

If the resources available to the entire network are not sufficient to configure all subnetworks, individual subnetworks or applications running therein can be prioritized in order to minimize the required resource budgets of the second controllers or even make them fully available to the remaining second controllers.

In one embodiment, determining the end-to-end configuration for the first layer is preceded by the step of:
detecting a network topology and any resource-binding entities in the first layer.

Resource-binding entities may be data streams, in particular video or audio streams, but also continuously acquired measurement data. All continuously present data streams known in advance in the network may be considered when allocating the resource budgets. This allows the allocation to be performed more efficiently.

In one embodiment, the first controller comprises a module for detecting the network topology and any resource-binding entities in the first layer.

The first controller may comprise a plurality of modules that perform various tasks. While the second controllers are configured by a configuration engine, a dedicated module for detecting applications and resource-binding entities within the network architecture may be present.

In one embodiment, the first layer is superordinate to the second layer.

In this embodiment, the first controller already has the end-to-end network view. Thus, in this case, no additional exchange of information between the first and second controllers is required in the setup phase.

In one embodiment, the second layer is superordinate to the first layer, and determining the end-to-end configuration is preceded by the step of:
transmitting subnetwork information from each second controller to the first controller, wherein the subnetwork information comprises:
   requirements for data traffic within the subnetwork; and
   the topology of the subnetwork.

In this embodiment, in which the second layer is superordinate to the first layer, the second controllers must inform the first controller of the data traffic in their subnet and their respective requirements. In addition, they must specify the DetNet topology in their layer, meaning that they name the gateway nodes in the DetNet layer.

In another embodiment, each second controller may also indicate the preferred gateway nodes for the existing TSN endpoints in its subnetwork. They consider the topology and performance within the respective subnetwork. In DetNet terminology, these gateway nodes are referred to as DetNet edge nodes.

In one embodiment, the resource budget is, in particular, a time budget for transmissions.

For example, each second controller within the network architecture may be assigned a fixed bandwidth such that each end device must transmit its data within a defined time window.

In one embodiment, the network architecture depicts the network within an industrial plant, and the subnetworks comprise a plurality of control units of devices of a machine, a part of a machine or a group of machines.

In this embodiment, the first layer may represent the top or superordinate network layer, which interfaces with external networks, in particular an intranet or the Internet. The second layer, on the other hand, is the layer of equipment and machines within an industrial plant. In this case, each subnetwork can include a plurality of (control) devices of a machine, a part of a complex machine or a group of machines interconnected within a subnetwork.

The industrial plant may therefore correspond to a factory, a production facility or line, or an individual plant.

In another aspect, the disclosure relates to a network architecture for an industrial plant, wherein the network architecture comprises a first layer and a second layer. The first layer and the second layer comprise means for performing a method as described above.

In a further aspect, the disclosure relates to a computer program with a program code for performing a method as described above when the computer program is executed on a computer.

In a further aspect, the disclosure relates to a computer readable data carrier with program code of a computer program for performing a method as described above when the computer program is executed on a computer.

In summary, the present disclosure provides a computer-implemented method for configuring a hierarchical network architecture, a network architecture and a computer program with program code and a computer-readable data carrier.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

It shows:

FIG. 1 schematically illustrates the arrangement of the DetNet layer and the TSN layer with respect to each other;

FIG. 2 schematically illustrates the communication within network architecture in accordance with an embodiment of the disclosure;

FIG. 3 schematically illustrates the structure of network architecture in accordance with an embodiment of the disclosure; and

FIG. 4 schematically illustrates the sequence of the method according to an embodiment.

### DETAILED DESCRIPTION

In the figures of the drawings, identical reference numbers denote identical or functionally identical elements, parts or components, unless stated otherwise.

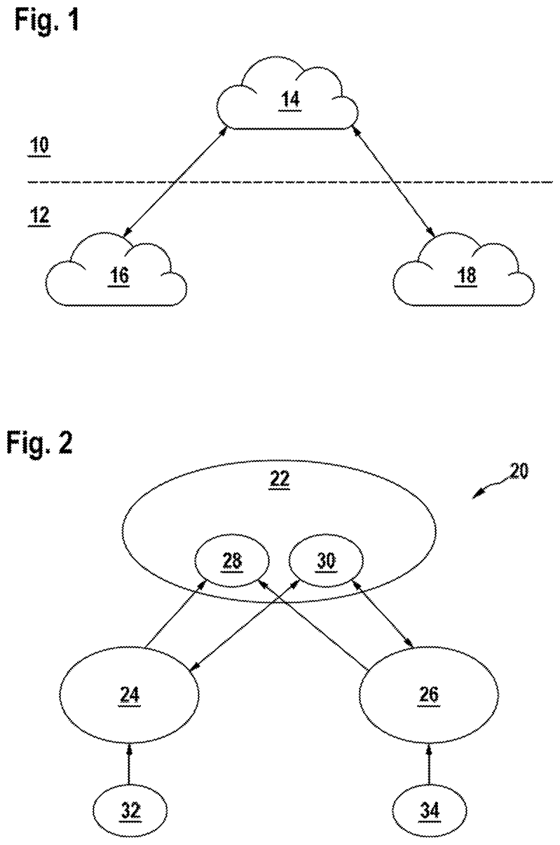

FIG. 1 schematically illustrates the arrangement of a DetNet layer and a TSN layer relative to each other. A first layer 10 is thereby superordinate to a second layer 12. Each layer has its own network components in sub-architectures 14, 16, and 18.

In a TSN-over-DetNet network architecture, the first layer 10 would be a DetNet layer and the second layer 12 would be a TSN layer. Accordingly, sub-architecture 14 would be the DetNet portion of the network architecture, and sub-architectures 16 and 18 would each be subnetworks having a TSN structure.

In an alternative DetNet-over-TSN network architecture, it would be reversed. Sub-architecture 14 would be a subnetwork with a TSN controller, and the first layer 10 would be the TSN layer. Furthermore, sub-architectures 16 and 18 would be DetNet networks, and the second layer 12 would be the DetNet layer accordingly.

FIG. 2 schematically illustrates the communication within a network architecture 20 in accordance with an embodiment. The network architecture 20 includes a DetNet controller 22 and two TSN controllers 24 and 26.

The DetNet controller 22 is configured to communicate with the TSN controllers 24 and 26. The TSN controllers 24 and 26 are unable to communicate directly with one another.

In a first step S10, a module 28 for detecting network activity and applications detects the topology and active resource-binding entities therein, such as applications and data streams. The end devices 32 and 34 located in the subnetworks of the TSN controllers 24 and 26 report their resource needs to the TSN controllers 24 and 26, which in turn communicate these resource needs to the module 28 for detecting network activity and applications.

If the topology and the applications are known within the network architecture 20, the DetNet controller 22 may determine a resource budget for the TSN controllers 24 and 26. For this task, the DetNet controller 22 has a configuration engine 30. The configuration engine 30 communicates to the TSN controllers the resource budgets allocated to them that are available to them for configuring their respective subnetworks.

The TSN controllers 24 and 26 may then check whether the resource budgets allocated to them are sufficient or whether they require more resources. If the resources are not sufficient, they report this back to the configuration engine 30, so that the DetNet controller 22 can redetermine the resource budgets and allocate them to the TSN controllers.

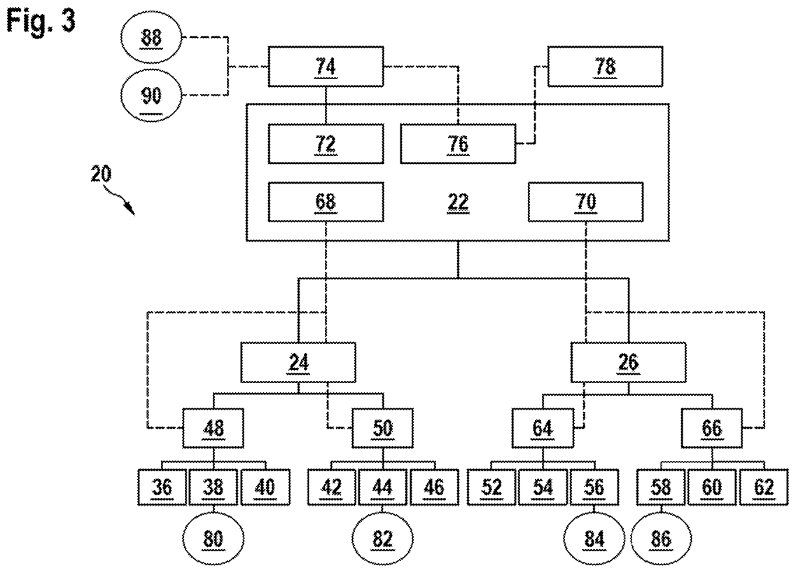

FIG. 3 schematically, and exemplarily, illustrates an industrial plant with a network architecture 20 in accordance with an embodiment of the disclosure. The network architecture 20 contains a DetNet controller 22 and two TSN controllers 24 and 26.

Each of the TSN controllers 24 and 26 is allocated to a separate subnetwork. The subnetwork of the TSN controller 24 includes end devices 36, 38, 40, 42, 44, and 46 connected together via two switches 48 and 50. The subnetwork of the TSN controller 26 includes end devices 52, 54, 56, 58, 60, and 62, which in turn are connected to each other via switches 64 and 66.

The DetNet controller 22 interfaces with an external network for end devices 36, 38, 40, 42, 44, 46, 52, 54, 56, 58, 60, and 62. To do this, the DetNet controller comprises two DetNet Edge nodes, or DetNet edge nodes 68 and 70, as well as a DetNet router 72.

The DetNet router 72 is connected to a backbone network 74, which communicates with the DetNet controller 22 via the DetNet edge node 76. Finally, the plant may be connected to an edge cloud or an edge cloud server 78, which also communicates with the DetNet controller 22 via the DetNet edge node 76.

For example, within the network architecture 20, four applications 80, 82, 84, and 86 may be executed. For example, application 80 has a cycle time of 1 ms and a payload of 300 B. It is executed by end device 38. Application 82 has a cycle time of 500 μs and a payload of 500 B. It is executed by end device 44. Application 84 has a cycle time of 4 ms and a payload of 1000 B. It is executed by end device 56. And application 86 has a cycle time of 1 ms and a payload of 1500 B. It is executed by end device 58.

In addition, two background applications 88 and 90 in the backbone network 74 are executed by nodes within the DetNet network. For example, background application 88 may be a video stream with a bandwidth requirement of 40 Mbps, while background application 90 is a video stream with a bandwidth requirement of 20 Mbps.

The DetNet controller 22 may detect background applications 88 and 90 through a module (not shown here) for detecting network activity and applications.

The DetNet controller 22 can obtain information about applications 80 and 82 via the TSN controller 24, and the DetNet controller 22 can obtain information about applications 84 and 86 via the TSN controller 26. It is further determined via which DetNet edge node 68, 70, 76 the applications are executed. Applications 80 and 82 are operated via DetNet edge node 68, and applications 84 and 86 are operated via DetNet edge node 70. All applications 80, 82, 84, and 86 communicate via DetNet edge node 76.

With this knowledge, the DetNet controller 22 determines a resource budget in the form of a defined time for the TSN controllers 24 and 26. To do this, it is first determined how many of the available resources need to be spent on background applications 88 and 90. The remaining resources are provided to the TSN controllers 24 and 26.

For example, the following resources may be allocated to the TSN controllers 24 and 26: To execute application 80, 250 μs are allocated by DetNet edge node 76 and 750 μs by DetNet edge node 68. To execute application 82, 250 μs are allocated by DetNet edge node 76 and 250 μs by DetNet edge node 68. To execute application 84, 500 μs are allocated by DetNet edge node 76 and 3.5 ms by DetNet edge node 70. To execute application 86, 500 μs are allocated by DetNet edge node 76 and 0.5 ms by DetNet edge node 70.

The TSN controllers 24 and 26 can distribute these within their subnetworks. If the resources are not sufficient to execute all applications in a subnet or to enable their communication with other participants in the network, then the TSN controller 24 or 26 that is not providing sufficient resources to its subnetwork reports this back to the DetNet controller 22. The DetNet controller 22 can then begin a new determination or allocation of the resource budgets for the TSN controllers 24 and 26. This process is repeated until the TSN controllers 24 and 26 have allocated sufficient resources to their subnetworks, or some of applications 80, 82, 84, and/or 86 have been turned off so that the remaining applications 80, 82, 84, and/or 86 can be executed.

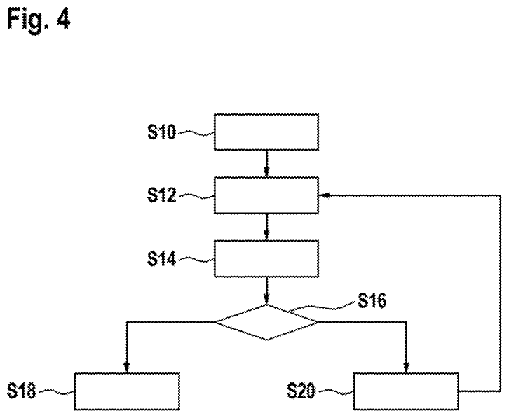

FIG. 4 shows schematically the process flow of the method for configuring network architecture according to one embodiment.

The method begins in step S10 with the DetNet controller detecting an end-to-end configuration for the DetNet layer. This end-to-end configuration contains paths that prevent impairment of the network when the network topology changes.

In step S12, a resource budget is allocated to each subnetwork in the TSN layer. This allocation is not yet an allocation of specific resources, since this is later performed by the respective TSN controller of the subnetwork.

In step S14, the DetNet controller transmits the resource budgets to the respective TSN controllers. The resource budgets need not be equally distributed. They can be tailored to the requirements of the applications running in the respective subnetwork, so that TSN controllers whose subnets run particularly resource-intensive applications can receive larger budgets from the outset than those that do not need such quantity of resources.

In step S16, each TSN controller checks for itself whether the resource budget allocated to it is sufficient to create a valid resource plan for its own subnetwork.

If each of the TSN controllers can create a resource plan for its own network with the resource budget allocated to it, then, in step S18, the subnetwork or the entire network architecture is configured accordingly.

If one of the TSN controllers cannot supply its subnetwork with sufficient network resources in step S16, that is, if the resource budget allocated to it is not sufficient to meet the requirements of its subnetwork, then, in step S20, the TSN controller transmits a response to the DetNet controller.

The DetNet controller then begins to re-allocate the resource budget according to step S12. In particular, it can take into account the requirements of the subnetworks if they were included in the response of the TSN controller in question.

Furthermore, the TSN controllers may be configured to also provide a response to the DetNet controller following the step of creating their resource plan, to inform it of any excess resources or to signal a successful creation of the resource plan.

What is claimed is:

1. A computer-implemented method for configuring a hierarchical network architecture, wherein the network architecture includes at least a first layer and a second layer, wherein the first layer includes a first controller, and wherein the second layer includes a plurality of subnetworks and, for each subnetwork, a second controller, the method comprising:
determining, by way of the first controller, an end-to-end configuration for the first layer;
allocating, by way of the first controller, a resource budget to each subnetwork corresponding to the end-to-end configuration;
communicating, by way of the first controller, the respective allocated resource budget to each second controller; and
creating, by way of each second controller, a resource plan for the subnetworks and configuring the network architecture if the resource budget transmitted to the second controller is sufficient, or transmitting a response from the second controller to the first controller if the transmitted resource budget is not sufficient for the second controller.

2. The computer-implemented method according to claim 1, wherein the first layer is a DetNet layer, and wherein the first controller is a DetNet controller.

3. The computer-implemented method according to claim 1, wherein the second layer is a TSN layer, and wherein the second controllers are TSN controllers.

4. The computer-implemented method according to claim 1, wherein the method is repeated if the resource budget is not sufficient for one of the second controllers.

5. The computer-implemented method according to claim 1, wherein the response includes a request for a larger resource budget for the resource budget.

6. The computer-implemented method according to claim 1, wherein the response includes an indication of a resource budget actually needed, and wherein the response is transmitted to the first controller even if the resource budget allocated to the respective second controller is sufficient.

7. The computer-implemented method according to claim 1, wherein the data traffic within the network architecture is restricted for one or more second controllers if the resource budget is not sufficient for one of the second controllers, and wherein a higher resource budget is allocated to the unrestricted second controllers.

8. The computer-implemented method according to claim 1, wherein determining the end-to-end configuration for the first layer is preceded by:
detecting a network topology and any resource-binding entities in the first layer.

9. The computer-implemented method according to claim 8, wherein the first controller includes a module for detecting the network topology and any resource-binding entities in the first layer.

10. The computer-implemented method according to claim 1, wherein the first layer is superordinate to the second layer.

11. The computer-implemented method according to claim 1, wherein the second layer is superordinate to the first layer, and wherein determining the end-to-end configuration is preceded by:
transmitting subnetwork information from each second controller to the first controller, wherein the subnetwork information comprises:
requirements for data traffic within the subnetwork; and
the topology of the subnetwork.

12. The computer-implemented method according to claim 1, wherein the network architecture depicts the network within an industrial plant, and wherein the subnetworks include a plurality of control units of devices of a machine, a part of a machine, or a group of machines.

13. A network architecture for an industrial facility, wherein the network architecture comprises a first layer and a second layer, and wherein the first layer and the second layer include means for performing the method according to claim 1.

14. A computer program with program code to execute the method according to claim 1 when the computer program is executed on a computer.

15. A computer-readable data carrier with program code of a computer program for performing the method according to claim 1 when the computer program is executed on a computer.

16. The computer-implemented method according to claim 1, wherein the response includes a request for a minimum size for the resource budget.
